(19) United States
(12) Patent Application Publication
(10) Pub. No.: US 2015/0127944 A1
(43) Pub. Date: May 7, 2015

(54) METHOD FOR SECURE AND ANONYMOUS ELECTRONIC COMMUNICATION VIA CRYPTOGRAPHY-FACILITATED DELIVERY

(71) Applicant: Ethan Wendel Bell, Lone Tree, CO (US)

(72) Inventor: Ethan Wendel Bell, Lone Tree, CO (US)

(21) Appl. No.: 14/069,543

(22) Filed: Nov. 1, 2013

(51) Int. Cl. H04L 9/32

(52) U.S. Cl. CPC H04L 9/3247
USPC 713/170

(57) ABSTRACT

A method for secure and anonymous electronic communication via cryptography-facilitated delivery. The method handles and delivers messages such that the intended recipients are not revealed to any third party, nor is the sender revealed to any third party other than the server (or equivalent distribution mechanism). Messages are cryptographically signed and encrypted by the sender, after which the resulting encrypted payloads are distributed to all clients. Clients then attempt to decrypt the payloads, where successful decryption indicates that a client is the intended recipient of a message. The decrypted message is then processed with all known public keys (of which the client is aware) to determine whether any of the keys successfully validate the message against the included signature provided by the sender. If the message is successfully validated, the recipient has successfully received the message and identified the sender.

### FIELD OF THE INVENTION

The present invention relates to electronic communication systems and, more specifically, a method for secure communication such that it is impossible for any third party to discern the identities of the communicating parties involved.

### BACKGROUND OF THE INVENTION

In present methods of electronic communication, encryption is commonplace and widely used. In such methods, the message payload (and occasionally some associated control information) is encrypted. While such communications may be encrypted end-to-end, servers are still responsible for routing communications between parties (be it in both centralized and distributed protocols). Therefore, this routing information can be potentially logged or monitored, ultimately generating “metadata” which could then be used to reveal or identify the intended recipient(s) and sending parties.

### BRIEF SUMMARY OF THE INVENTION

Embodiments of the present invention overcome the shortcoming described above by providing a method that does not route encrypted messages explicitly between the communicating parties. The method delivers all messages to all users and relies on cryptographic operations to filter for relevant messages and identify the sender to only the desired recipient(s).

To send a message, the message payload is signed and encrypted by the sender, which is then sent to the server. This step does not differ from present methods. However, the server must only store the message payload (and perhaps, for added convenience, the timestamp of receipt). The identities of the sender and intended recipient(s) are not necessary to complete delivery. While the sender's IP address is available to the server (and could therefore be logged), the unencrypted message contents and intended recipient(s) are unknown. Further, this makes it impossible to determine whether subsequent messages from the same sender are related to previous messages or intended for the same recipient(s).

In present methods, only pertinent messages are routed and delivered to specific clients. By contrast, the server in the present invention only acts as a repository for messages. It does not route or selectively deliver messages. Instead, all messages are delivered to all clients. As a result, it is impossible for the server to determine which clients are interested in which messages, which ultimately maintains anonymity for the intended recipient(s).

After receiving the message repository from the server, each client must determine which messages are actually relevant. In the present invention, this is possible as a result of the cryptographic operations that were performed by the sender prior to transmission. The client attempts to decrypt each message payload using its cryptographic key(s) (the specific type of keys required vary depending on the encryption type). The client will only successfully decrypt messages for which it has the appropriate key, indicating that it is the intended recipient. Once the message payload is decrypted, the accompanying message signature makes it possible to determine and verify the identity of the sender.

### DETAILED DESCRIPTION OF THE INVENTION

The method proposed by the present invention uses cryptography to facilitate message delivery between parties. Both asymmetric or symmetric cryptography can be used, though the embodiments may vary slightly for each.

In general, embodiments can either implement a centralized or distributed network in which all messages are ultimately delivered to all clients. The server (or equivalent mechanism) is solely responsible for receiving messages, adding messages to the message repository and disseminating the message repository to clients. When requesting the message repository, clients may provide the server with a last-updated timestamp to request only the messages that were received since that time.

Embodiments may rely on asymmetric cryptography for all operations or a combination of both asymmetric and symmetric cryptography. As such, either asymmetric or symmetric cryptography can be used to encrypt and decrypt messages. In both cases, however, asymmetric cryptography is used for message signatures and validation, and parties must exchange public keys in order to validate (and, in the case of a strictly asymmetric embodiment, exchange) messages. If symmetric cryptography is used in conjunction with asymmetric cryptography, the communicating parties must also exchange the appropriate symmetric key to encrypt and decrypt messages for every group of communicating parties (or every “conversation”).

To send a message, the client will first sign the message using its private key. Then, the message payload (consisting of the message and its signature) will be encrypted using either the recipient's public key (in an asymmetric embodiment) or the conversation's symmetric key (in a symmetric embodiment). Finally, the encrypted payload is sent to the server, which is then disseminated to all other clients.

When a client receives a message repository update from the server, it iterates through each new message and attempts to decrypt the message payload. For an asymmetric embodiment, this requires attempting to decrypt each payload using the client's private key. For a symmetric embodiment, the client must attempt to decrypt each message using each symmetric key of which it is aware. Regardless of the embodiment type, if a message payload is successfully decrypted, the client has received a message for which it was the intended recipient.

In order to discern the identity of the message sender, the client then iterates through its list of known public keys to determine whether any key validates the message contents against the included signature. If the message validates successfully, the client has successfully resolved the sender's identity. However, if the message fails to validate against any of the known public keys, the message was either modified in transit or was sent by a party whose identity is presently unknown to the client.

The present invention is independent of and can be used with any cryptographic algorithm (or algorithms in the case of a hybrid asymmetric+symmetric cryptography embodiment) that provide the ability to sign, encrypt, decrypt and verify messages. Further, the method is capable of handling any message payload, including text, images or any other kind of binary data. The method does not require any specific network protocol or structure, so long as all messages are delivered to all clients. Finally, it is evident that many alternatives, equivalents, variations and modifications would be, or are, apparent to those of ordinary skill in the applicable arts. Accordingly, such alternatives, equivalents, variations and modifications that are within the spirit of the disclosed subject matter are embraced within the present invention.

What is claimed is:

1. A method for electronically delivering a payload facilitated by cryptography where:
the payload is comprised of a message and its cryptographic signature, fully encrypted;
the method comprising the steps of:
disseminating the payload to all clients via a server or equivalent mechanism;
attempting to decrypt and validate the message by receiving clients.

2. The method of claim 1, where the sender of the payload is not required to (and should not) provide information regarding its identity or the intended recipient(s) to any other party.

3. The method of claim 1, where an intended recipient of a payload determines that it is the recipient via the successful decryption of the payload.

4. The method of claim 1, where, upon successful decryption of the payload, the sender's identity is determined by using the cryptographic signature provided within the decrypted payload and the recipient's list of known keys to check if any one of the keys successfully validates the decrypted message against the included message signature.
